(19) United States
(12) Patent Application Publication
(10) Pub. No.: US 2011/0186100 A1
(43) Pub. Date: Aug. 4, 2011

(54) Observation blind having decorative insulated panels and method for panel manufacture

(76) Inventor: Joel W. Bolin, Hempstead, TX (US)

(21) Appl. No.: 12/657,927

(22) Filed: Jan. 29, 2010

(51) Int. Cl. E04H 15/34; E04H 15/56; E04H 15/54; E04H 15/58; B29C 44/02

(52) U.S. Cl. 135/121; 264/41

(57) ABSTRACT

A blind or shelter has a base structure with a framework mounted to the base structure and defines an access door opening. Composite wall and roof panels are mounted to the framework and have an intermediate structural core being embedded within a body of polymer foam material. At least some of the composite wall panels have window openings with window assemblies and define transparent moveable window panes for the window openings. An access door assembly is pivotally supported by the framework and is composed of a composite door panel formed of polymer foam material having a structural core panel embedded therein. The polymer foam is molded to have the appearance of faux tree bark or to have any other desired external appearance.

### BACKGROUND OF THE INVENTION

1. Field of the Invention

The present invention relates generally to observation blinds or shelters that are used for shelter and concealment of users for wildlife viewing during outdoor activities such as, photography, hunting, wildlife conservation and for numerous other similar outdoor activities. This invention also concerns the provision of blind structures having an external surface appearance that substantially simulates a wooded environment or other selected environment within which an observation blind is located, so that animals nearby will not be disturbed by the appearance of the blind and tend to avoid coming close to it. The blind structure has wall, door, windows, roof and floor components that provide efficient thermal insulation and resist damage and deterioration during a wide range of weather conditions. While the shelter structure of the present invention is referred to herein as an “observation blind”, it is to be understood that the scope of this invention encompasses various small building structures that may serve as shelters for wildlife observation, nature watching, photography and the the like or may serve as a protective shelter for a school bus stop for children and may even serve efficiently as an outhouse for use in remote locations.

2. Description of the Prior Art

The term “blind” is intended to encompass a wide variety small shelters that provide shelter and may also provide for concealment for one or more persons, depending on the physical size of the structure. The term is also intended to encompass a wide variety of small shelters that are typically used to provide one or more users with protection from the uncomfortable effects of weather conditions such as rain, snow, wind and the like. Though the present invention is referred to herein as a “blind”, it is not intended to limit the spirit and scope of the blind to structures and shelters for hunting activities, since structures manufactured according to this invention will have a wide range of effective use.

Blinds have been widely used for many years by hunters, birders and others that have an interest in outdoor activities concerning wildlife. Historically, blind structures have been homebuilt, i.e., designed and manufactured from readily available materials by a user for the user's intended purpose. Most blinds have been constructed of wood, such as plywood and many of them are designed to be mounted onto or supported by towers that provide the blind with sufficient elevation so that the user will be less likely to be noticed and avoided by certain wildlife, such as deer. In many cases the exterior surfaces of the wall structure of the blinds are painted to closely emulate the conditions of the environment within which the blind is to be used. Such blinds are often painted with a desired color or color pattern, such as a camouflage pattern so that it is less obvious to the wildlife wildlife that the user or users are intending to observe.

A primary disadvantage of this kind of homemade blind is that they are not particularly weather resistant, so that they deteriorate rapidly and must be extensively repaired or replaced within a couple of years. More recently, blinds, particularly deer hunting blinds, have become commercially available. Though manufacture of commercially available blinds tends to vary widely, a type of blind that is commercially available at the present time has a wood framework, with plastic panels fixed to the framework to define wall structures. A similar plastic panel is typically used for the roof structure of the blind. These types of blinds will typically have an access door of similar construction and window closures that are pivotally mounted so that they can be raised when the blind is in use, thus permitting the user to look through window openings to view the surrounding area. In some cases sliding windows are provided so that the user is able to look through window panes and slide the window panes to a partially open condition when taking photographs or conducting hunting activities. The sliding window panes provide the user with more comfortable conditions when uncomfortable weather conditions are encountered, but typically permit ingress of water during rain and snow conditions which promotes deterioration of the typically wood blind structure. However, the usual plastic covered wall panels provide virtually no thermal protection for the user; thus the user must dress according to the prevalent weather conditions as if located outdoors and must be prepared to accommodate abnormally high temperatures or wide ranges of temperatures especially on sunny days, since the dark plastic panels tend to absorb heat.

### SUMMARY OF THE INVENTION

It is a principal feature of the present invention to provide a novel blind structure that is composed of thermally insulated wall panels to promote the comfort of the user even during uncomfortable weather conditions, particularly cold conditions where ice and snow may be present.

It is another feature of the present invention to provide a novel blind structure that is provided with decorative external surfaces that have the appearance of tree bark or are otherwise treated to have an external appearance that closely simulates the outdoor environment within which the blind is situated.

It is also a feature of the present invention to provide a novel blind structure that is composed of materials that resist damage or degradation resulting from the influence of weather conditions so that the blind structure will remain in serviceable condition for long periods of time without needing extensive maintenance or restoration.

It is another feature of the present invention to provide a novel blind structure that incorporates a window assembly having a moveable window panel or pane having a unique window design that prevents the influx of water into the finished shelter. The blind is constructed of materials that effectively resist deterioration by weather.

It is also a feature of the present invention to provide a novel blind or shelter structure that has a metal framework to which is attached a plurality of composite wall and roof panels each having a body of polymer foam material of controlled density, with a structural panel embedded within the polymer foam and enhancing the structural integrity of the composite wall and roof panels.

It is another important feature of the present invention to provide a novel method or process for manufacturing the composite wall and roof panels of the present invention to provide the generally flat panels with a decorative outer surface closely representing a selected tree bark geometry or other selected geometry and to provide the panels with a good thermal insulating quality and weather resistant quality for the comfort of the users and for the efficient use and durability of the blind or shelter structure.

It is an even further feature of the present invention to provide a novel blind or shelter structure having a metal framework structure including a framework base defining a floor panel receptacle receiving a floor panel and defining leg brackets that are oriented to establish predetermined orientation of leg members that can be attached to the leg brackets to suitably elevate the blind or shelter above the ground.

Briefly, the various objects and features of the present invention are realized through the provision of a novel blind or shelter structure that is composed of composite panels that are fixed to a metal or other substantially rigid framework. The composite panels are typically composed of a body of polymer foam material within which is embedded a structural panel that can be composed of oriented strand board or composed of a suitable metal or polymer material to enhance the structural integrity of the polymer foam material. If desired the panels may include 4′×8′ sheets of 7/16″ Oriented Strand Board (OSB) onto which a ¼″ fiberglass strand mesh is affixed on the exterior face side over panel cutouts for the adhesion of three dimensional polymer foam faux tree bark to be applied. The panel can be made any size necessary, such as 4′×4′, 4′×8′, or larger. The resulting wall and roof panels may be connected by a structural framework member to define a “double wide” blind or shelter structure embodying the principles embodying the principles of the present invention.

The polymer foam faux tree bark design of the exterior surface portions of the composite panels provide the blind with effective camouflage so that wildlife near the blind will not tend to avoid the blind. Voids can be cut in the OSB panel to reduce the overall weight of the composite panels and to allow the lightweight foam to constitute the majority of the upper portion of the overall panel. The polymer foam material has insulating properties and, while still a thin lightweight panel, offers excellent thermal protection for the occupants of the completed blind structure.

The composite panel contains the structural member of the OSB behind the faux tree bark surface, resulting in a rigid structural panel that is thin, lightweight, attractive, and easy to transport and assemble.

The composite panel is molded with pre-existing openings for a side window or a door. The sill of the window has channels at the bottom that direct water to the outside of the structure. The exterior of the window pane rests flush with the top of the interior frame such that water cannot get in. The “glass” or other transparent pane of the window is encircled in a soft felt material such that the window movement is a little stiff in the frame and the “glass” slides silently when opening and closing the window. The stiffness in sliding provides friction resistance to window movement and allows the window pane to remain partially open without further support or stops.

The composite panel may have threaded attachment holes ( 5/16″ T-Nuts) attached at strategic locations, used 1) during the manufacture to maintain an even thickness of the board as the polymeric foam expands to form the faux tree bark surface, and 2) during assembly of the panels to form the side walls of the structure and to attach them to the floor and roof assembly, and to support auxiliary items such as small shelves or arm/foot rests inside the blind. The panels are built with a uniform bolting or fastening pattern to enable a multitude of assembly options for the various panels that are manufactured individually. For assembly of an alternative character fastener screws may be extended through framework openings and may be threaded through the polymer material and into the OSB or other structural material for simple and efficient retention.

Structural integrity of the blind or shelter 10 is enhanced by a series of angle brackets that are attached to the upper corners of the panels by bolts arranged in a crossing pattern. The brackets enable tight 90 degree connections of the side panels and also allow attachment of the roof section of the structure at the four corners of the structure through a hole drilled through the bracket parallel to the wall and perpendicular to the roof section. One long side edge (96″) of the panel is molded “around the corner” such that when assembled there is no visible side view of the edge of the OSB/polymer foam composite panel. Panels are overlapped at the corners to hide the interior edge of the panel.

The three dimensional faux tree bark surface closely resembles actual pine or oak or any type of tree bark, including all of the intricate detail of actual tree bark such as undercuts, ridges, grooves, layering, and other surface irregularities. Any bark pattern may be applied. Any other pattern, such as camouflage canvas, may be applied to the exterior surface of the panel.

The faux tree bark is made in an RTV silicone mold with a condensation (tin-cure) silicone. The silicone is similar to the characteristics of GT Product's GT 5092 High Strength Silicone RTV (Room Temperature Vulcanizing) mold making rubber.

The resulting faux tree bark has a high degree of hardness due to the high density polymer foam material that is achieved by the panel molding process. This high polymer foam density is achieved during the molding of the bark by allowing the poured polymeric foam to degas and partially rise in the bottom half of the mold, then, before the foam fully sets, compressing the rising foam with the lid of the mold, resulting in the foam filling the voids around the OSB structural panel and into the areas of the bark pattern on the surface. The increased pressure maintained during the setting of the foam results in a foam of increased density and hardness. Coloring of the tree bark (foam exterior surface) is achieved by dying the foam prior to pouring and by the use of a colored mold release agent in the RTV mold. The mold release agent is irregularly applied and results in an irregular discoloring of the exterior bark surface of the finished panel, resembling the irregular coloring of actual tree bark.

The composite panels can be used to make structures with a floor surface of 4′×4′, 4′×8′, or larger. Height of the panels determines the height of the structure. The floor of the structure is designed to connect directly to the faux tree bark panels by means of bolts and brackets, resulting in a structure that is easy and fast to assemble, and easy and fast to disassemble.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is an isometric illustration showing a blind or shelter structure embodying the principles of the present invention;

FIG. 2 is an elevation view showing the front wall portion of the framework structure of the blind or shelter structure of FIG. 1;

FIG. 2A is an elevation view of the door frame portion of the framework structure of FIGS. 1 and 2;

FIG. 2B is a sectional view taken along line 2B-2B of FIG. 2, showing a portion of the front wall framework of FIG. 2;

FIG. 3 is a plan view showing the floor support portion of the framework of FIGS. 1 and 2;

FIG. 4 is an elevation view showing a side portion of the framework of FIGS. 1 and 2;

FIG. 5 is an elevation view showing the front portion of the framework of FIGS. 1 and 2;

FIG. 6 is an isometric illustration showing the support base structure of the blind or shelter of FIGS. 1-5;

FIG. 7 is another isometric illustration similar to the illustration of FIG. 7 and additionally showing a floor panel in place and showing the bottom portions of wall panels fixed thereto;

FIG. 8 is a sectional view of a schematic illustration of a mold and press that are employed during manufacture of the composite panels of the present invention;

FIG. 9 is a fragmentary sectional view of a mold assembly for molding composite wall panels having the “molding around the corner” feature of the present invention;

FIG. 10 is an exterior elevation view showing a part of a wall of the blind or shelter of the present invention and showing a window assembly installed within a window opening;

FIG. 11 is an isometric illustration showing a part of a window frame assembly of FIGS. 9 and 10 and showing grooves in frame and sill members to provide for window movement and water drainage;

FIG. 12 is an interior elevation view showing a part of a composite wall panel of the present invention and showing the interior details of a window assembly installed within a window opening;

FIG. 13 is an isometric illustration showing the window sill and an upright window member that is a component of the window assembly of FIG. 12;

FIG. 14 is a partial section view showing the upper portion of the blind or shelter of the present invention and particularly showing mounting of a roof panel to the side walls and covering the top wall; and

FIG. 15 is a partial section view of a wall panel of the present invention showing a window closure panel being pivotally mounted for opening and closing movement and in broken lines being shown to be supported at the open position thereof relative to a window opening.

### DETAILED DESCRIPTION OF PREFERRED EMBODIMENT

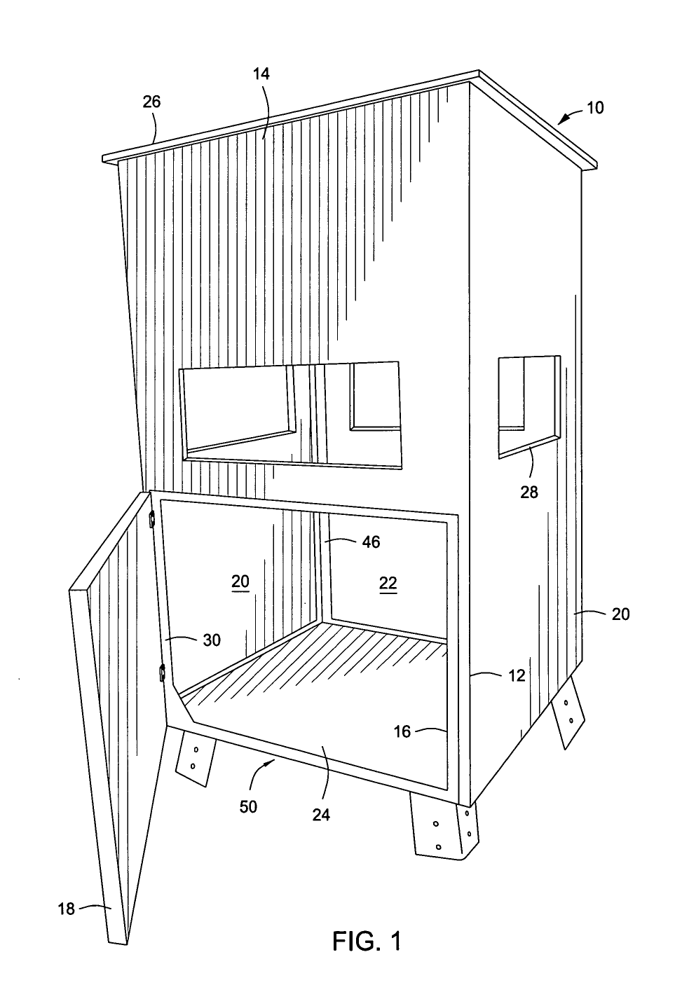

Referring now to the drawings and first to FIG. 1, a blind or shelter structure embodying the principles of the present invention is shown generally at 10 and has a substantially rigid framework shown generally at 12 that is preferably composed of steel framework members, but may be composed of any other suitable, substantially rigid framework members such as might be composed of a polymer material, wood or a suitable composite material. The blind structure 10 has a front wall having a front wall panel 14 defining a door opening 16, the door opening being closed by a pivotally mounted access door 18. The access door is shown to be substantially half the height of the front wall panel 14, but it is to be understood that the access door may extend substantially the full height of the wall panel. When a full height access door is employed the structural framework will not include intermediate horizontal structural members such as is shown at 34 and 40. The blind structure 10 also has side walls 20, a rear wall 22, a bottom wall or floor 24 and a top wall or roof 26, all of which will be described in detail hereinbelow. The front, side and rear walls of the blind or shelter 10 each preferably define window openings such as shown at 28 within which window units are mounted.

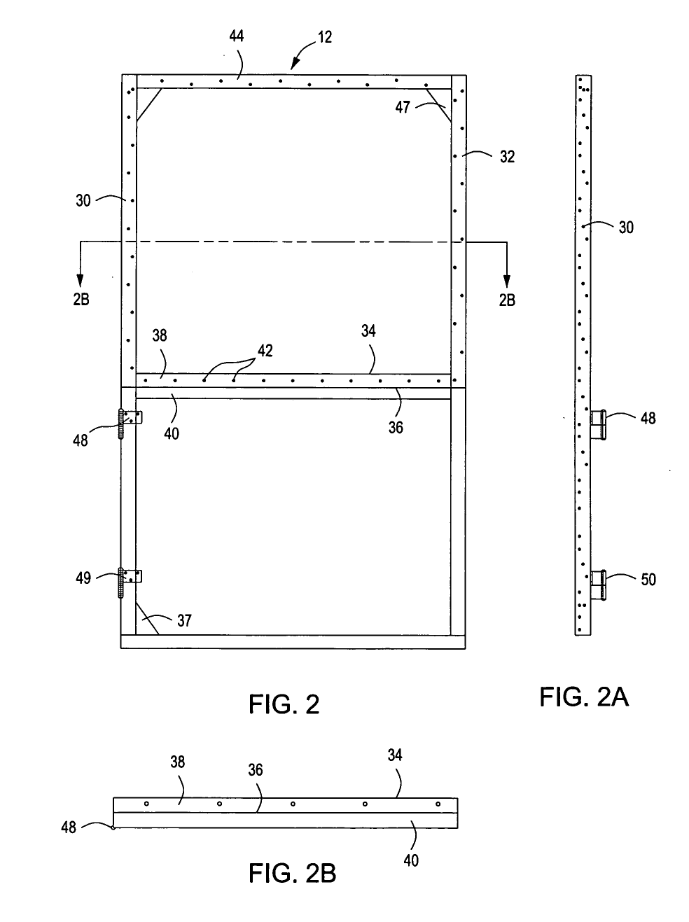

The substantially rigid framework 12, as shown in FIGS. 2, 2A, 2B and 3-5, is defined by a front panel frame having vertical side members 30 and 32 to which the ends of an intermediate transverse frame member 34 are fixed. The intermediate transverse frame member defines a substantially horizontally oriented flange member 36 and substantially vertically oriented flanges 38 and 40. Flange 36 serves as a front wall panel support while the vertically oriented flange 38 is provided with fastener openings 42 to permit the front wall panel 14 to be secured in place by means of screws, bolts or other suitable fasteners. The lower vertical flange 40 serves as an abutment flange that is engaged by the pivotally mounted door 18 when the door is closed. The vertical framework members 30 and 32 and a top horizontal frame member 44 also define a desired number of fastener openings as shown in FIG. 2 for secure mounting of the front wall panel 14 to the framework of the blind structure. If desired, the wall panels and the roof panel may have standard T-nuts embedded therein or mounted thereto to enable quick assembly and disassembly of the blind or shelter structure as desired.

Substantially vertically oriented framework members, such as shown at 46 in FIG. 1, and upper horizontal framework members in the form of angle members complete the rear portion of the framework structure and facilitate mounting side and rear wall panels to the framework to define the blind or shelter. The upper portion of the front and rear frames of the framework structure is strengthened by the presence of gusset members 47 that are connected with the vertical and horizontal framework members at each upper corner for the framework assembly. For pivotal mounting of an access door, a pair of hinge members 48 and 49 are mounted to the vertical frame member 30, such as by means of screws, bolts or other suitable fasteners as shown in FIGS. 2 and 2A. In the region of the lower hinge member 49 the framework includes a gusset member 51 for efficiency and structural efficiency and structural integrity of the support structure for the access door 18.

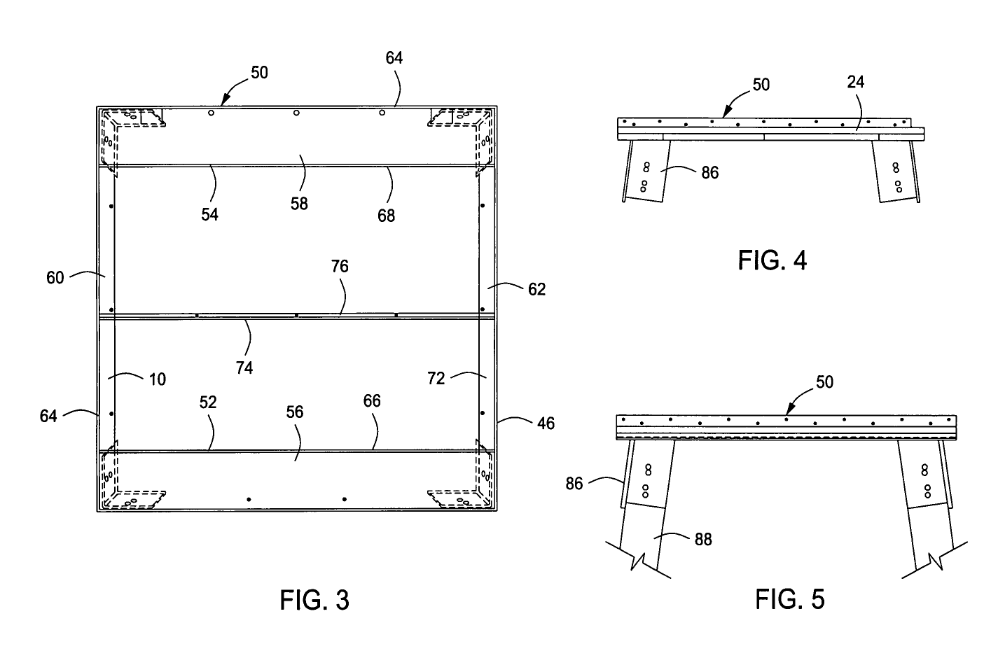

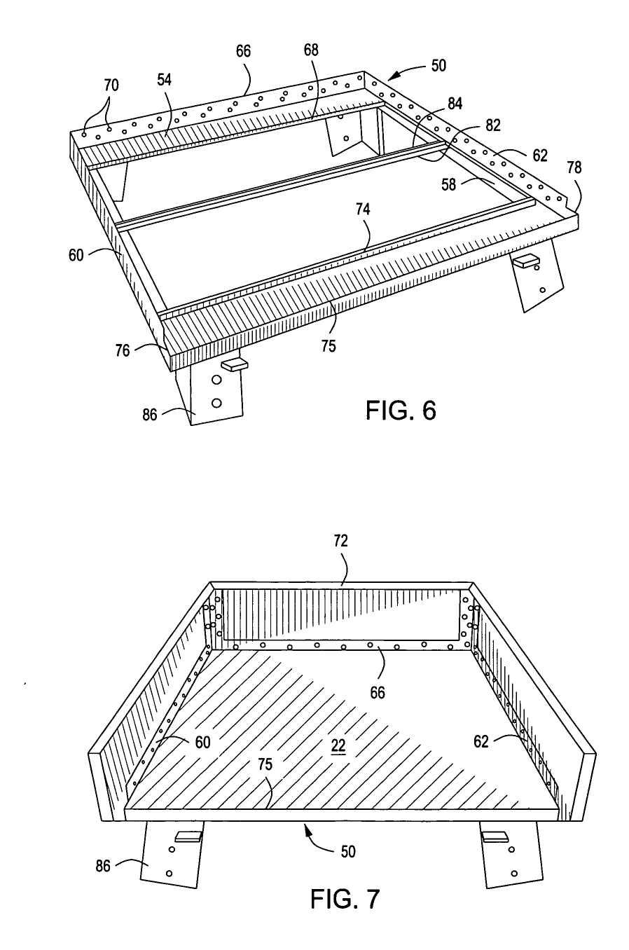

Referring now to FIGS. 3-5, the framework 12 of the observation blind or shelter 10 defines a support platform structure shown generally at 50, having front and rear generally horizontally oriented floor and wall support members 52 and 54. The horizontally oriented floor and wall support members 52 and 54 are connected with side support structural members 56 and 58, each having upstanding wall support flanges 60 and 62. The horizontally oriented front and rear floor and wall support members 52 and 54 are preferably composed of metal angle members that are manufactured from steel, though other substantially rigid materials such as aluminum, polymers and the like may be employed within the spirit and scope of the present invention.

The rear floor and wall support member 54 defines an upstanding rear wall mounting flange 66 and an upstanding floor support flange 68. The rear wall mounting flange 66 defines a number of fastener holes 70 that permit a rear wall panel 72 to be mounted thereto by means of screws or other suitable fasteners. The upstanding side wall mounting flanges 60 and 62 of the side support structural members 56 and 58 are also provided with a number of fastener holes to receive wall mounting fastener devices. If the wall panels are fitted with predetermined mounting devices such as T-nuts, screws extending through the fastener holes 70 can simply be threaded into the T-nuts and tightened. This feature permits ease of assembly and disassembly of the blind or shelter via the use of a simple tool such as a screw driver.

The front floor and wall support member 52 defines an upstanding floor panel positioning flange 74, a front floor panel locating flange 75 and floor panel positioning side flanges 76 and 78 that that assist positioning of the rectangular floor panel 22 as shown in FIG. 7. Ordinarily the floor panel will simply rest within its receptacle; however if desired the floor panel may be fastened in place via the use of screws or other suitable fasteners.

An intermediate cross support member 82 has end portions thereof supported by and mounted to the horizontally oriented floor support flanges 56 and 58 and defines an upstanding intermediate floor support flange 84. The upper edges of the floor panel support flanges 68, 74 and 84 are disposed in co-planar and substantially equidistant relation to provide efficient support for the planar floor panel 22. The floor positioning flange 75 of the floor and wall support member 52 extends to a height above the upper edge of the floor support flange 74 that is equal to the thickness of the rectangular floor panel 80 so that the upper edge of the floor support flange substantially lies in a plane within which the upper planar surface of the floor panel 80 also lies. This feature ensures that an upstanding edge is not present at the threshold of the entry door that might cause persons to trip when exiting the door opening. The structural components, particularly the upstanding wall mounting and floor positioning flanges of the support platform base structure 50, effectively define a generally rectangular floor receptacle within which the rectangular floor panel 22 is positioned. The upstanding flanges that define the floor receptacle effectively prevent lateral shifting of the floor panel. The floor panel 22 may be composed of plywood if desired or may be composed of a composite polymer foam embedded oriented strand board (OSB) especially to provide the floor structure with an efficient thermal insulating quality. The upper planar surface of the floor panel 22 may be covered with a panel of carpet if desired to ensure against excessive noise that might be caused by the movement of an caused by the movement of an observer or the observer's equipment within the blind.

Though the observation blind or shelter 10 may be supported on or near ground level, it is typically desirable to provide it with an elevated tower-like support so that inspecting personnel can be located above the typical line of sight of deer and many other species of animal. As shown in FIGS. 3-5 support brackets 86 are located at each corner of the rectangular support platform or base structure 50 and are suitably angulated so that support legs 88, bolted or otherwise mounted to the support brackets will be more widely spread at the bottom than at the top, thus providing the observation blind or shelter 10 with enhanced stability.

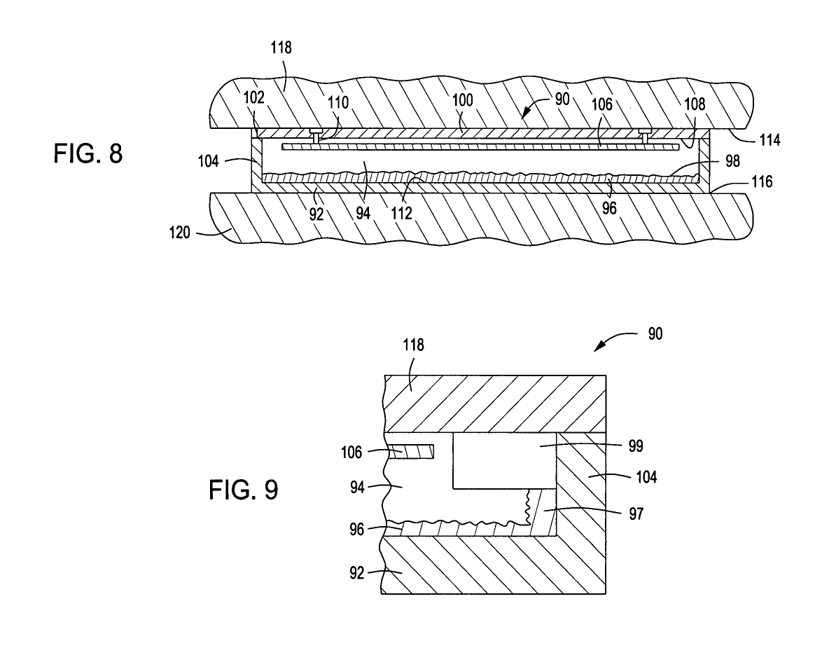

With reference particularly to FIG. 8 the immovable wall, floor and roof/ceiling panels and the pivotally movable door panel of the observation blind or shelter 10 are broadly defined as polymer foam/OSB composite wall panels, which are also referred to herein as composite panels. For manufacture of the composite panels a mold shown generally at 90 is defined by a mold base 92 that forms a mold pocket or cavity 94.

A decorative mold member or body 96, preferably composed of yieldable or resilient RTV silicone composition, is positioned within the mold cavity and defines a decorative molding surface 98 having a desired three dimensional configuration that is desired for the exterior surface of the composite panel. The decorative surface may conveniently have the appearance and three dimensional configuration of faux tree bark, thus enabling a decorative three dimensional faux tree bark pattern to be molded onto dense polymer foam material during the molding process. The decorative three dimensional faux tree bark pattern that constitutes the outer decorative surface of the composite panels establishes the general appearance of the blind or shelter 10.

Preferably the decorative mold member or body 96, when a faux tree bark surface is desired, is prepared by scanning real tree bark with a computer scanner and generating an electronic data file representing the geometric design of the bark. The electronic data file is then employed to produce a substantially rigid flat mold surface having corresponding tree bark configuration. A quantity of RTV silicone material is then prepared and poured into the flat mold to a desired thickness to accommodate the geometry of the substantially rigid flat mold surface. After the RTV silicone material has cured it is then removed from the rigid flat mold and is then placed within the mold cavity 94 where it rests on the surface of the bottom wall of the mold base 92 with the three dimensional decorative mold surface facing upwardly. Both the substantially rigid flat mold surface and the RTV silicone mold body 96 may be re-used many times and will be replaced only with they become worn or degraded to the point that the appearance of the resulting decorative faux tree bark configuration should become degraded.

A mold closure or lid 100 engages the rim surfaces 102 of the side walls 104 of the mold base 92 and defines a seal for the mold base to close and seal the mold pocket or cavity 94. A structural member or panel 106 is supported within the mold pocket by the mold closure or lid 100 and is embedded within the dense polymer foam material during the molding process. The structural member or panel 106 is preferably supported in spaced relation with the inner surface 108 of the closure or lid, such as by being releasably supported by a plurality of support members 110. For example, in one application of the present invention the spacing of the structural member from the inner surface of the mold closure or lid is in the order of from about ¼ inch to about ⅜ inch. This spacing will permit fasteners such as screws to be threaded through the polymer foam material and into the OSB structural panel for efficient structural retention. However, this particular spacing is not intended to limit the spirit and scope of the present invention since any desired spacing of the structural member may be employed. According to the preferred embodiment of the present invention the structural member may conveniently take the form of sheets of oriented strand board (OSB). Though the panel of OSB material may have any desired thickness, it has been determined that for the weight and structural integrity of the composite wall and roof panels of the present invention an OSB panel thickness of about 7/16″ is optimum. However, within the spirit and scope of the present invention OSB panels having a wide range of thicknesses can be effectively employed.

The composite panel molding process is conducted by placing the decorative mold member 96 within the mold pocket 94 and in engagement with the bottom wall surface 112 of the mold base. The decorative RTV silicone mold member 96 is maintained within the mold cavity during the molding of a number of the composite panels. In the event it should become damaged or worn during successive use, the decorative RTV silicone mold member 96 is easily replaced. A panel 106 of OSB material of desired dimension and configuration is then attached to the inner surface portion of the closure 100 in spaced relation with the inner surface of the closure. A quantity of polymer foam material in its uncured essentially liquid state is then poured into the mold pocket or cavity 94 where it conforms to the configuration of the three dimensional decorative surface 98 of the RTV silicone body 96, including overhanging or undercut regions.

The polymer foam material is prepared to include a UV resisting agent and can include other materials that will promote extensive service life of the resulting blind or shelter structure. The mold closure is then positioned with its closure edges in sealing contact with the rims 102 of the walls of the mold base. The mold is then placed between the upper and lower surfaces 114 and 116 of the platens 118 and 120 of a press. Sufficient mechanical pressure is applied to the mold by the mold platens to ensure that the polymer foam material is contained within the mold cavity during the molding process. During the molding process the polymer foam material will expand during its curing to completely fill the mold cavity and to become formed about the panel of OSB material. As the polymer foam material expands and flows during its polymerization it also fills the space between the mold closure and the OSB panel and conforms to the flat inner surface 108 of the mold closure 100. This molding process causes the panel of OSB material to be completely embedded within the molded composite panel. As the polymer foam expands during its curing process the mechanical pressure that is applied by the platens of the press causes the density of the polymer foam to increase, thus enhancing the structural integrity and thermal resistance of the completed composite panel.

The density and thermal resistance of the resulting polymer foam body is accomplished by allowing the poured polymeric foam to degas and partially rise in the bottom half of the mold, then, before the foam fully sets, compressing the rising foam with the lid of the mold, resulting in the foam filling the voids around the OSB structural panel and into the areas of the tree bark or other suitable pattern on the surface. The increased pressure maintained during the during the setting of the foam results in a polymer foam panel body of increased density and hardness. Coloring of the tree bark (foam exterior surface) is achieved by dying the foam prior to pouring and by the use of a colored mold release agent in the RTV mold. The mold release agent is irregularly applied and results in an irregular discoloring of the exterior bark surface of the finished panel, resembling the irregular coloring of actual tree bark.

After the polymer foam material has become cured to the extent that it will maintain its molded configuration the platens of the press will be moved apart, releasing the mechanical pressure on the mold 90. The mold will then be removed from the press. The closure panel 100 will then be released and removed from the walls of the mold base, causing the support members 110 to become released from the embedded panel 106 of OSB material 106. The completed composite panel will then be removed from the mold with sufficient force to pull the molded decorative surface of the composite panel from the decorative molding surface of the RTV silicone body 96. The resilient yieldable nature of the RTV silicone body 96 will permit the three dimensional decorative surface of the composite panel to be pulled free of the three dimensional decorative surface 98. If desired, the decorative surface of the molded composite panel may then be spray painted so that its appearance will have a desired color pattern for the environment within which the blind or shelter is intended to be located.

The mold cavity and the RTV silicone mold are designed, when desired, to provide certain composite panels with non jointed corners so that a straight vertical corner line is not visible in the completed shelter structure. The fragmentary sectional view of this type of mold is shown in FIG. 9. This feature is known as “molding around the corner”. For example, the front and rear wall panels of a blind or shelter may be molded around the corner and the side wall panels will have straight edges that engage the front and rear panels along vertical side edges that are defined by adjacent wall panels. For around the corner molding, a decorative mold body 96 will be prepared having a corner section 97. Strip blocks 99 will then be fixed either to the side walls within the mold base or to the mold closure 118. The molding process will then be conducted in the same manner as described above. For example, the front and rear wall panels of the blind structure can be panels having molded corners. The adjacent side panels will simply have straight edges that abut the corner sections 97.

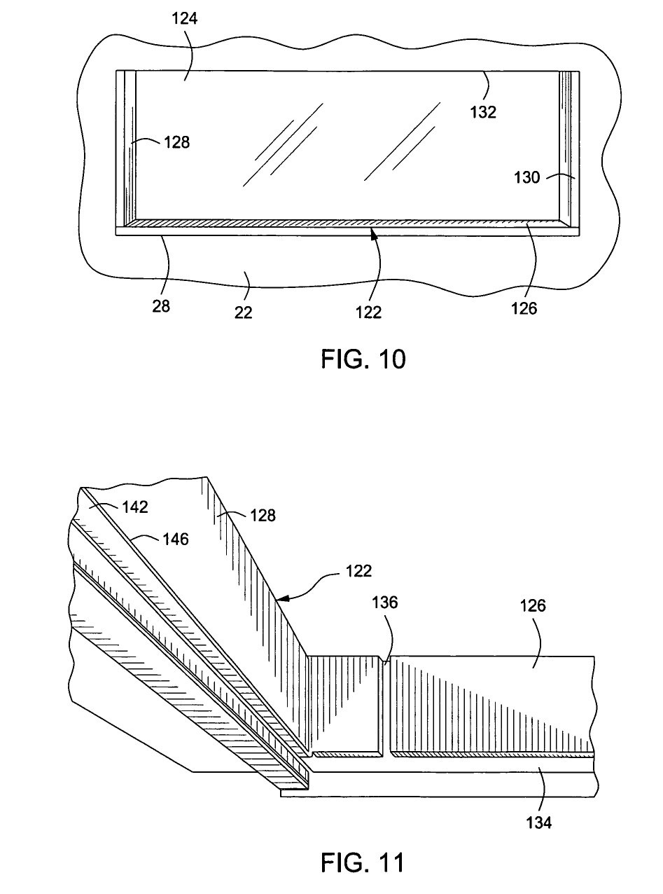

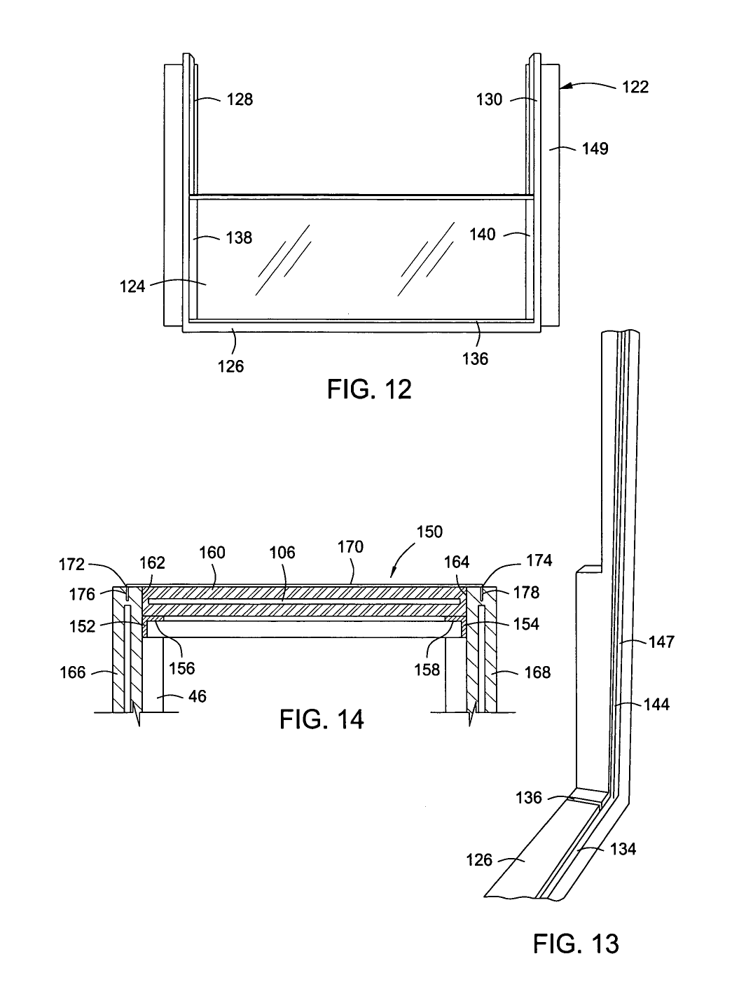

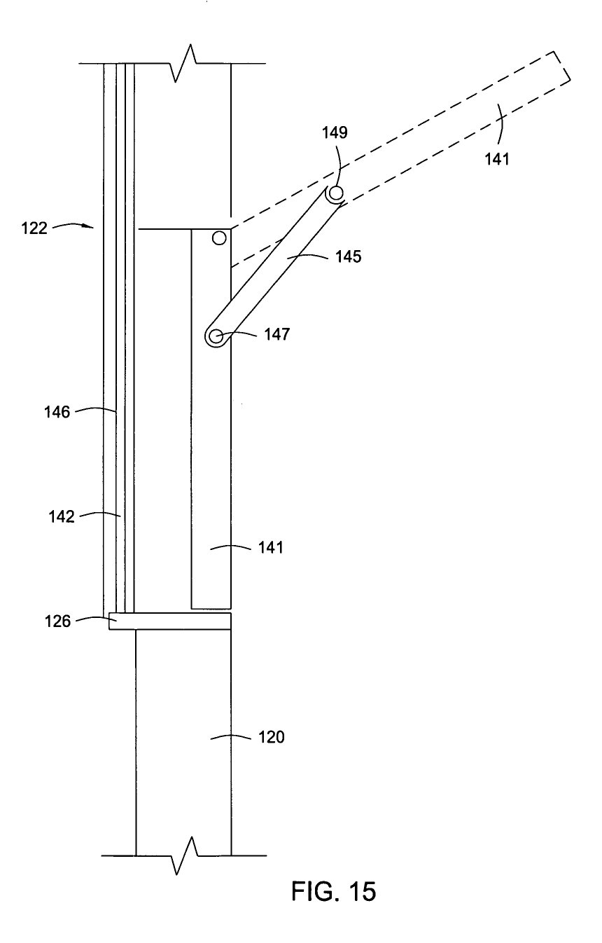

When the walls of the blind or shelter 10 are provided with windows, a window blank will be positioned within the mold cavity so that the completed molded composite panels will have a window opening such as is shown at 28 in FIGS. 1 and 10. A weather resistant window assembly, shown generally at 122 in FIG. 10 is mounted within the window opening 28 of the composite wall panel 22, forming a weather resistant closure for the window opening and providing the user with the capability of looking through a window pane 124 of the window assembly to visualize the environment within which the blind or shelter 10 is located. As shown in FIG. 12 the window assembly 122 is defined by a generally horizontal window sill 126 and upright window guide frame members 128 and 130 which project upwardly from the window sill and project beyond the upper edge 132 of the window opening 28. As shown best in FIG. 11 the window sill 126 defines a longitudinal groove 134 that is located intermediate the width of the window sill and which receives the lower edge trim portion 136 of the the lower edge trim portion 136 of the window pane 124 and serves to provide a weather seal for the lower portion of the window pane. Any water that may enter the longitudinal groove 134 will be drained via lateral drain grooves 135 that extend laterally from the longitudinal groove.

The window pane also has side edge trim 138 and 140 which are moveably received within edge grooves 142 and 144 of window pane guide channel members 146 and 147 that are each received within vertical grooves of the upright window guide frame members 128 and 130. The edge trim 138 and 140 is preferably composed of a soft felt material so that the window panes may be moved easily and quietly with respect to the vertical guide channels of the window pane guide channel members 146 and 147. If desired any of a wide variety of window pane trim materials such as polymer, rubber or metal may be employed without departing from the spirit and scope of the present invention. The window guide channel members 146 and 147 are preferably composed of a weather resistant metal such as an aluminum alloy, but could be composed of a suitable polymer material or a wide range of other materials if desired.

It should be noted that the vertical grooves 142 and 144 extend upwardly well beyond the upper edge 132 of the window opening. This feature permits the window pane to be moved upwardly from its lower closed position to an open position where the window pane is located above the window opening. The side trim of the window pane is of a dimension having a sufficient friction fit within the vertical grooves 142 and 144 to permit the window pane to be moved upwardly or downwardly by application of manual force. This friction fit will maintain the window pane against inadvertent movement and permit it to be quietly moved by a sliding action to any desired location between its fully open and fully closed positions. The vertical grooves are preferably open at their upper ends so that the window pane may be completely removed from the window assembly if desired. This feature permits the window pane to be simply, efficiently and quietly replaced by a darker or lighter window pane to accommodate various light conditions. If desired however, the vertical window pane slots 142 and 144 may have window pane stops that may be defined by the heads of screws that extend through the channel members and into the polymer foam and/or OSB material of the composite panels. The interior portions of the window assemblies 122 are preferably finished by vertical molding strips 148 and 149.

When the blind or shelter 10 is not being used the window openings and window assemblies are protected by a window closure panel 141 that is mounted to the composite wall panel by a pivot mount 143. The window closure panel 141 is maintained at an open position by a support bar member 145 that is mounted to the wall panel structure by a pivot 139 and engages a stop member 149 to secure the window closure panel at its open position.

With reference particularly to FIG. 14, the blind or shelter structure 10 of the present invention will be provided with a composite roof assembly which is indicated generally at 150. The substantially rigid framework 12 incorporates upper angle members two of which are identified at 152 and 154. The upper angle members have roof panel support flanges, two of which are indicated at 156 and 158. Collectively, the roof panel support flanges define a rectangular edge support for a composite roof panel 160 that is constructed according to the panel manufacturing process that is described above. The composite roof panel 160 is strengthened by an embedded panel 106 of OSB material, metal mesh material or any other suitable material that is embedded within the molded body of polymer foam. To ensure exclusion of water from the joints 162 and 164 of the side walls 166 and 168 a roof panel 170 which is preferably composed of sheet metal, such as 24 gauge galvanized steel, is mounted to cover the upper surface of the composite roof panel 160 and to cover the edge joints 162 and 164 between the roof panel and the side walls of the blind or shelter structure. The upper edges of the wall panels 166 and 168 define upwardly opening slots 172 and 174 within which are received downturned edge flanges 176 and 178 of the roof panel 170. Any water that enters the upwardly facing slots 172 and 174 will be drained from the open ends of the slots.

All of the material from which the blind or shelter 10 is composed are weather resistant and resistant to dry rot or other types of material degradation. The polymer foam material is prepared to be resistant to damage by ultra violet rays. Accordingly, the blind or shelter of the present invention is adapted to efficiently withstand the ravages of all types of weather conditions and will therefore provide many years of efficient service.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A blind or shelter comprising:
a base structure;
a framework mounted to said base structure and defining an access door opening;
composite wall and roof panels of molded polymer foam materials being mounted to said framework;
at least some of said composite wall panels defining window openings;
window assemblies being mounted to said composite wall panels and defining substantially transparent moveable closures for said window openings; and
an access door assembly being pivotally supported by said framework and forming a closure for said access door opening, said access door assembly having a composite door panel formed of polymer foam material and having a structural core panel embedded therein.

2. The blind or shelter of claim 1, comprising:
said composite wall and door panels having an exterior surface defining surface irregularities including undercut parts, ridges and depressions.

3. The blind or shelter of claim 1, comprising:
said composite wall and door panels having a rough exterior surface representing faux tree bark and defining exterior surface irregularities including undercut parts, ridges and depressions.

4. The blind or shelter of claim 1, comprising:
said exterior surface of said composite wall panels being formed by polymer foam material molded within a mold having a mold surface defined by a body of resilient mold material having sufficient resiliency and tear resistance to permit release of exterior surface irregularities including undercut parts, ridges and depressions of said body of polymer foam material from said mold surface of said body of resilient mold material after curing of said polymer foam material.

5. The blind or shelter of claim 4, comprising:
said body of resilient mold material being composed of RTV silicone material.

6. The blind or shelter of claim 4, comprising:
said mold surface of said body of resilient mold material being generated from electronic computer data derived by scanning a natural tree bark surface and employing the electronic computer data to form a likeness of the natural tree bark surface on a body of mold material; and
molding said body of resilient mold material to the electronic computer data prepared body of mold material to form said mold surface of said body of resilient mold material.

7. The blind or shelter of claim 4, comprising:
said body of resilient mold material being removable from a mold along with said composite wall panel after curing of said body of polymer foam material; and
said body of resilient mold material being subjected to a pulling force to separate said mold mold surface of said body of resilient mold material and said body of polymer foam material and being re-used during molding of a number of similar composite wall or roof panels.

8. The blind or shelter of claim 4, said base structure comprising:
a generally rectangular base frame defining a floor panel receptacle and defining floor support members; and
a floor panel being located within said floor panel receptacle and being supported by said floor support members.

9. The blind or shelter of claim 8, comprising:
leg bracket members depending from said generally rectangular base frame and adapted for supported connection with leg members to position said blind or shelter above ground level, said leg bracket members being oriented to establish desired orientation of the leg members.

10. The blind or shelter of claim 1, comprising:
said framework having front and rear wall panel support frames each having substantially vertically oriented corner framework members having ends of a roof support frame member fixed thereto and having corner gusset members fixed to said substantially vertically oriented corner framework members having and to said roof support frame member;
roof and side wall panel support frame members having ends thereof mounted to said front and rear wall frames;
said composite wall panels being mounted to said base structure to said substantially vertically oriented corner framework members and said roof support frame member; and
a composite roof panel being mounted to said roof support frame members and said roof side support frame members.

11. The blind or shelter of claim 10, comprising:
at least some of said composite wall panels having upper edges defining upwardly opening grooves extending the length thereof; and
a metal roof panel having downturned edges received within said upwardly opening grooves and having a central portion disposed in surface to surface engagement with said composite roof panel and covering joints of said composite roof panel with said composite wall panels.

12. The blind or shelter of claim 1, said base structure comprising:
floor and wall structural members defining a floor receptacle and having composite wall panel mounting flanges;
a floor panel being positioned within said floor receptacle;
said composite wall panels being fastened to said composite wall panel mounting flanges; and
leg mount members being fixed to said floor and wall structural members and being adapted for connection of leg members thereto, said leg mount members being oriented for desired leg positioning.

13. The blind or shelter of claim 12, said base structure comprising:
said floor and wall structural members being spaced generally C-shaped channel members each having a first upstanding outer wall support flange and a second upstanding channel flange of less height than said first upstanding outer wall support flange and defining a floor panel support flange;
an intermediate floor support member having ends supported by said floor and wall support structural members and having a height substantially equal to the height of said second upstanding floor support channel flanges;
a side support member having ends fixed to said floor and wall structural members; and
said floor panel being supported by said second upstanding channel flange member and said intermediate floor support member.

14. The blind or shelter of claim 1, comprising:
said composite wall and roof panels being molded polymer foam material and having an intermediate structural core embedded therein and providing structural integrity therefore.

15. The blind or shelter of claim 1, comprising:
window closure panels being pivotally mounted to said composite wall panels at said window openings and being moveable from a closed position to an open position permitting viewing through said window assemblies; and
window panel support members being pivotally mounted to said composite wall panels within said window openings and having a position supporting said window closure panels at said said open position thereof.

16. A method for manufacturing composite wall and roof panels for a blind or shelter, comprising:
providing a mold having a mold bottom wall and mold side walls defining a mold opening and having therein, said mold further having a mold closure for closing said mold opening;
positioning a body of resilient mold material on said bottom wall, said body of resilient material having a molding surface defining ridges, grooves and undercut surface features and cooperating with said mold side walls and said mold closure to define a mold cavity;
depositing a quantity of mixed and uncured polymer foam material within said mold cavity;
positioning a panel of structural material within said mold cavity in spaced relation with said molding surface, said mold side walls and said mold closure and closing said mold with said mold closure, expansion of said polymer foam material during polymerization causing said polymer foam material to completely fill said mold cavity and enclose said panel of structural material;
restraining said mold and said mold closure against displacement and deformation by said expanding polymer foam material until said polymer foam material has expanded to its maximum extent and has cured to form a composite panel of desired density;
removing said mold closure from said mold; and
separating said body of resilient mold material and said composite panel.

17. The method of claim 16, wherein said restraining step comprises:
after closing said mold with said mold closure placing said mold and mold closure between platens of a press and applying sufficient force to said mold and mold closure to restrain them against being yielded by the pressure of expanding polymer foam material within said mold cavity.

18. The method of claim 16, comprising:
applying a release agent of desired color to said mold surface in irregular manner to provide said composite panel with an irregular color pattern;
after curing of said polymer foam material and removing said mold closure from said mold, removing both said composite panel and said body of resilient mold material from said mold; and
applying a selective peeling force to said composite panel and said body of resilient mold material to peel said body of resilient mold material from said composite panel, said body of resilient mold material resisting tearing and other mold surface degradation during peeling of said body of resilient mold material from said composite panel.

19. The method of claim 16, wherein said positioning of said panel of structural material comprising:
releasably supporting said panel of structural material in spaced relation with said mold closure with one or more releasable support devices such that said panel of structural material is disposed in spaced relation with said mold closure;
after said step of depositing a quantity of mixed and uncured polymer foam material within said mold cavity positioning and securing said mold closure in closing position with said mold; and
upon removing said mold closure from said mold said releasable support devices releasing support of said panel of structural material leaving it embedded within said polymer foam material of said composite panel.

20. The method of claim 16, wherein the density and thermal resistance of said polymer foam material is controlled by:
allowing the poured polymeric foam to degas and partially rise in the bottom half of the mold;
before the polymer foam fully sets compressing the rising foam with the lid of the mold causing the polymer foam to expand and fill the voids around the OSB structural panel and expand into the areas of the bark pattern on the surface; and
maintaining sufficient pressure on the polymer foam material during its setting and curing to resist free expansion thereof and achieve a polymer foam of increased density and hardness.
